(19) United States
(12) Patent Application Publication
(10) Pub. No.: US 2026/0169787 A1
(43) Pub. Date: Jun. 18, 2026

(54) VIRTUAL NODE PROVISIONING SYSTEM AND METHOD

(71) Applicant: SAMSUNG ELECTRONICS CO., LTD., Suwon-si (KR)

(72) Inventors: Ho Sung BAEK, Suwon-si (KR); Kyu Byeong JEONG, Suwon-si (KR); Ha Ram RYU, Suwon-si (KR); Min Kyo JUNG, Suwon-si (KR)

(73) Assignee: SAMSUNG ELECTRONICS CO., LTD., Suwon-si (KR)

(21) Appl. No.: 19/251,260

(22) Filed: Jun. 26, 2025

(30) Foreign Application Priority Data
Dec. 18, 2024 (KR) 10-2024-0189895

(51) Int. Cl. G06F 9/455

(52) U.S. Cl. CPC G06F 9/45558; G06F 2009/45595

(57) ABSTRACT

According to an aspect of the present disclosure, a virtual node provisioning system includes a server pool and a provisioning management device. The server pool includes hosts and is configured to provision, based on a virtual node provisioning command, a service provisioning node, which includes virtual nodes, on one or more of the hosts. The provisioning management device executes instructions to receive a provisioning request, obtain decision variables representing provisioning locations in the server pool for provisioning optimization target nodes included in the virtual nodes of the service provisioning node, compute, based on the decision variables, a solution of an objective function that minimizes an underlay traffic volume of the provisioning optimization target nodes being provisioned at the provisioning locations, generate, based on the solution of the objective function, the virtual node provisioning command corresponding to the provisioning request, and transmit, to the server pool, the virtual node provisioning command.

### CROSS-REFERENCE TO RELATED APPLICATIONS

This application claims benefit of priority under 35 U.S.C. § 119 to Korean Patent Application No. 10-2024-0189895, filed on Dec. 18, 2024, in the Korean Intellectual Property Office, the disclosure of which is incorporated by reference herein in its entirety.

### BACKGROUND

### 1. Field

The present disclosure relates generally to virtual computing environments, and more particularly, to a system and method for provisioning virtual nodes based on network traffic usage.

### 2. Description of Related Art

Various virtual nodes, such as, but not limited to, virtual machines and containers, may be provisioned on hosts that may be equipped with middleware such as, but not limited to, hypervisors. Typically, hosts may form a server pool together with other multiple hosts. However, depending on physical network connections of the hosts where virtual nodes may be provisioned, inefficiencies in network traffic usage may arise.

For example, when two virtual machines are provisioned on hosts in response to a provisioning request for a service provisioning node composed of the two (2) virtual machines, the number of hops in the east-west overlay traffic between the two (2) virtual machines may only be one (1). However, the number of hops in the east-west underlay traffic between the two (2) virtual machines may vary significantly depending on whether the virtual machines are provisioned by the same host, hosts within the same rack, hosts in different racks within the same availability zone (AZ), or hosts located in different AZs.

Similarly, north-south underlay traffic may also experience inefficiencies in network traffic usage depending on the network topology positions of the hosts where virtual nodes are provisioned. For example, when service provisioning nodes consisting of networking nodes, such as, but not limited to, edge nodes or load balancing nodes, and compute nodes (e.g., virtual machines) are provisioned on hosts, the number of hops in north-south traffic in overlay traffic may only be two (2) including one (1) hop between the compute nodes and the load balancing nodes and one (1) hop between the load balancing nodes and the edge nodes. However, the number of hops in north-south underlay traffic for the compute nodes may vary greatly depending on the physical network connections of the hosts provisioning the compute nodes, edge nodes, load balancing nodes, or the like.

However, related virtual node provisioning technologies may automatically determine provisioning target hosts based on the availability of host resources (e.g., processing resources and/or memory resources) or based on provisioning target host determination rules that may have been specified by users. Consequently, these technologies may not efficiently determine provisioning target hosts automatically based on underlay traffic usage for service provisioning nodes.

### SUMMARY

One or more example embodiments of the present disclosure provide a computing system for implementing a system and method for provisioning virtual nodes in an efficient manner in terms of network traffic usage, when compared to related virtual node provisioning systems.

Further, one or more example embodiments of the present disclosure provide a method for determining provisioning target hosts optimized in terms of east-west underlay traffic between service provisioning nodes and a computing system for performing the method.

Further, one or more example embodiments of the present disclosure provide a method for determining provisioning target hosts optimized in terms of north-south underlay traffic between compute nodes of service provisioning nodes and an external network, and a computing system for performing the method.

Further, one or more example embodiments of the present disclosure provide a method for determining optimal provisioning target hosts by finding the optimal solution to an optimization problem and a computing system for performing the method.

Further, one or more example embodiments of the present disclosure provide an optimization problem-based virtual node provisioning method and system for determining optimal provisioning target hosts by finding the optimal solution of an objective function reflecting actual traffic generated during the operation of service provisioning nodes.

The example embodiments of the present disclosure are not limited to those mentioned above, and other embodiments not explicitly stated may be clearly understood by those skilled in the art based on the following detailed description.

According to an aspect of the present disclosure, a virtual node provisioning system includes a server pool and a provisioning management device. The server pool includes a plurality of hosts. The server pool is configured to provision, based on a virtual node provisioning command, a service provisioning node on one or more hosts of the plurality of hosts. The service provisioning node includes a plurality of virtual nodes. The provisioning management device includes one or more processors including processing circuitry, and a memory storing instructions. The instructions, when executed by the one or more processors individually or collectively, cause the provisioning management device to receive a provisioning request for the service provisioning node, obtain decision variables representing provisioning locations in the server pool for provisioning optimization target nodes included in the plurality of virtual nodes of the service provisioning node, compute, based on the decision variables, a solution of an objective function that minimizes an underlay traffic volume of the provisioning optimization target nodes being provisioned at the provisioning locations, generate, based on the solution of the objective function, the virtual node provisioning command corresponding to the provisioning request, and transmit, to the server pool, the virtual node provisioning command. The underlay traffic volume includes a sum of an east-west traffic volume between the provisioning optimization target nodes and a north-south traffic volume between the provisioning optimization target nodes and an external network.

According to an aspect of the present disclosure, a virtual node provisioning method performed by a computing system includes obtaining a provisioning request for a service provisioning node including a plurality of virtual nodes, generating, using an optimization problem solver, a virtual node provisioning command corresponding to the provisioning request, and provisioning the service provisioning node on one or more hosts of a plurality of hosts of a server pool by transmitting the virtual node provisioning command to the server pool including hosts where the plurality of virtual nodes are to be provisioned. The generating of the virtual node provisioning command includes obtaining decision variables representing provisioning locations in the server pool for provisioning optimization target nodes included in the plurality of virtual nodes of the service provisioning node, iteratively computing output values of an objective function, while varying the decision variables, determining a solution of the objective function based on a minimum of the output values of the objective function, obtaining selected decision variables from among the decision variables corresponding to the solution, and generating the virtual node provisioning command based on the selected decision variables. The objective function calculates an underlay traffic volume of the provisioning optimization target nodes being provisioned at the provisioning locations. The underlay traffic volume includes a sum of an east-west traffic volume between the provisioning optimization target nodes and a north-south traffic volume between the provisioning optimization target nodes and an external network.

Additional aspects may be set forth in part in the description which follows and, in part, may be apparent from the description, and/or may be learned by practice of the presented embodiments.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 is a configuration diagram of a virtual node provisioning system, according to an embodiment of the present disclosure;

FIG. 2 is a block diagram of a provisioning manager, according to an embodiment of the present disclosure;

FIGS. 3 and 4 are configuration diagrams of server pools, according to some embodiments of the present disclosure;

FIG. 5 is a first configuration diagram of an exemplary service provisioning node, according to some embodiments of the present disclosure;

FIGS. 6 to 9 are diagrams illustrating varying numbers of east-west traffic hops between virtual nodes depending on the physical network connections between provisioning target hosts of the service provisioning node of FIG. 5, according to some embodiments of the present disclosure;

FIG. 10 is a configuration diagram of an exemplary service provisioning node, according to some embodiments of the present disclosure;

FIGS. 11 to 14 are diagrams illustrating how the number of north-south traffic hops for compute nodes varies depending on the physical network connections of provisioning target hosts of the exemplary service provisioning node of FIG. 10, according to some embodiments of the present disclosure;

FIGS. 15 to 17 are flowcharts of a virtual node provisioning method, according to an embodiment of the present disclosure; and

FIG. 18 is a hardware configuration diagram of a computing system, according to an embodiment of the present disclosure.

### DETAILED DESCRIPTION

Hereinafter, example embodiments of the present disclosure are described with reference to the attached drawings. The advantages and features of the disclosure and methods of accomplishing the same may be understood more readily by reference to the following detailed description of example embodiments and the accompanying drawings. The present disclosure may, however, be embodied in many different forms and should not be construed as being limited to the example embodiments set forth herein. Rather, these embodiments are provided so that the present disclosure is thorough and complete and fully conveys the concepts of the present disclosure to those skilled in the art, and the present disclosure is defined by the appended claims and their equivalents. In describing the present disclosure, if it is determined that a detailed description of a related known configuration or function may obscure the gist of the disclosure, the detailed description may be omitted.

The singular expressions used in the following embodiments may include plural concepts, unless the context clearly specifies singularity. Additionally, plural expressions may include singular concepts, unless the context clearly specifies plurality. In addition, terms such as first, second, A, B, (a), (b) used in the following embodiments are only used to distinguish one element from another element, and the terms do not limit the nature, sequence, or order of the relevant elements.

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The elements described with reference to terms such as unit, module, block, ˜or, ˜er, or the like may be used in the present disclosure and the functional blocks shown in the drawings may be implemented in the form of software, hardware, or a combination thereof. For example, the software may be machine code, firmware, embedded code, and application software. As another example, the hardware may include an electrical circuit, an electronic circuit, a processor, a computer, an integrated circuit, integrated circuit cores, passive components, or a combination thereof. The above hardware may be virtualized hardware. For example, the hardware may indicate a virtualized processor, virtualized memory, or virtualized storage.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

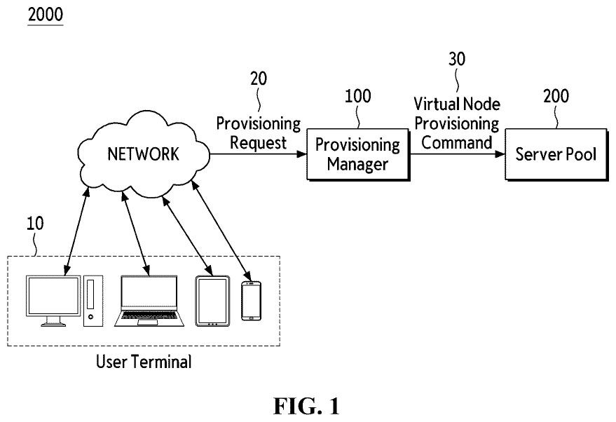

The configuration and operation of a virtual node provisioning system, according to an embodiment of the present disclosure, is hereinafter described with reference to FIG. 1.

The virtual node provisioning system 2000, according to an embodiment of the present disclosure, may include a provisioning manager 100. The provisioning manager 100 may be implemented as one or more physical computing devices.

The provisioning manager 100 may obtain a provisioning request 20 for a service provisioning node including a plurality of virtual nodes. The provisioning manager 100 may receive the provisioning request 20 over a network from a user terminal 10 using a cloud service and/or may obtain the provisioning request 20 by querying a database of previously received and stored provisioning request records.

As used herein, the virtual nodes may include, but not be limited to, compute nodes that may execute user-level applications and non-compute node type virtual nodes. The non-compute node type virtual nodes may include networking nodes such as, but not limited to, load balancing nodes, edge nodes, firewall nodes performing firewall functions, or the like. In the present disclosure, the virtual nodes other than the compute nodes may be referred to by their functional names, for example, load balancing nodes, edge nodes, firewall nodes, or the like. Therefore, devices referred to as virtual nodes, such as a first virtual node or a second virtual node, may be understood to refer to compute nodes.

Exemplary compute nodes may be and/or may include virtual machines. However, it is to be understood that the compute nodes of the present disclosure may encompass various types of virtual nodes, allocated virtual processors, and virtual memories to execute user-level applications. For example, the compute nodes may also refer to containers.

The provisioning manager 100 may generate a virtual node provisioning command 30 corresponding to the obtained provisioning request 20 and transmit the virtual node provisioning command 30 to a server pool 200 so that the virtual nodes of the service provisioning node in the provisioning request 20 may be provisioned on provisioning target hosts in the server pool 200.

The virtual node provisioning command 30 generated by the provisioning manager 100 may include specification information of the virtual nodes and identification information of the provisioning target hosts. The provisioning request 20 obtained by the provisioning manager 100 may include information regarding the service provisioning node but may not include the identification information of the provisioning target hosts. That is, the provisioning manager 100 may autonomously determine the provisioning target hosts for the virtual nodes included in the service provisioning node.

The provisioning manager 100 may generate information in a predefined format representing the service provisioning node including a plurality of virtual nodes using the information included in the provisioning request 20. The predefined format may be and/or may include a graph structure where nodes may represent virtual nodes and edges may represent network traffic between the nodes. The edges may have traffic volume as an attribute. The nodes may be and/or may include compute nodes and/or virtual nodes other than compute nodes. The information in the graph format may be used to construct an objective function.

The provisioning manager 100 may generate the virtual node provisioning command 30 for compute nodes in the service provisioning node using an optimization problem solver. In some embodiments, the provisioning optimization performed by the provisioning manager 100 may target the compute nodes within the service provisioning node. In an embodiment, it may be more efficient to concentrate networking nodes, such as, but not limited to, edge nodes, load balancing nodes, or the like, on specific racks in the server pool 200. Therefore, there may be no need to determine provisioning target hosts for such networking nodes using the optimization problem solver. Consequently, by limiting the targets of provisioning optimization to the compute nodes in the service provisioning node, the computational load required for provisioning optimization may be reduced.

The optimization problem solver, as a module of the provisioning manager 100, may be understood as a module that may calculate an optimal solution of the objective function by receiving decision variables representing the provisioning locations of provisioning optimization target nodes within the server pool 200. In an embodiment, the optimization problem solver may be implemented as software executed by the provisioning manager 100.

The objective function, whose function value may be calculated through the operation of the optimization problem solver, may refer to a function that may calculate the amount of underlay traffic generated when the provisioning optimization target nodes are provisioned at the provisioning locations. In the present disclosure, underlay traffic may refer to the physical traffic exchanged between physical hosts and may be distinguished from overlay traffic, which may refer to encapsulated traffic exchanged at virtualized network layers.

The amount of underlay traffic may be the sum of east-west traffic between the provisioning optimization target nodes and north-south traffic between the provisioning optimization target nodes and an external network. As used herein, east-west traffic may refer to internal communication traffic between different network devices, servers, or virtual machines within a same network fabric. In addition, north-south traffic may refer to data flowing between internal devices and external networks, such as, but not limited to, other external systems.

The optimization problem solver, by solving an optimization problem, may calculate provisioning locations within the server pool 200 for the provisioning optimization target nodes that may minimize the amount of underlay traffic amount, including both east-west and north-south underlay traffic.

That is, the function value of the objective function may represent the amount of underlay traffic generated when the provisioning optimization target nodes are provisioned, and a solution that minimizes the amount of underlay traffic may be determined to be the optimal solution. The optimization problem solver may repeatedly calculate the function value of the objective function by varying the decision variables to find decision variables that may produce an optimal solution. The decision variables may be varied within a range that may satisfy specific constraints.

In some embodiments, the provisioning manager 100 may generate the virtual node provisioning command 30 in response to receiving the provisioning request 20.

In other embodiments, the provisioning manager 100 may insert the received provisioning request 20 into a queue and generate a virtual node provisioning command 30 for each provisioning request 20 inserted in the queue as batch processing when the number of provisioning requests 20 inserted in the queue reaches a threshold. For example, the provisioning manager 100 may schedule a plurality of re-provisioning tasks for the service provisioning node already in operation to be executed as batch processes, thereby efficiently utilizing idle computing resources during off-peak hours (e.g., evening or nighttime), when new provisioning requests 20 may be infrequently received from user terminals 10.

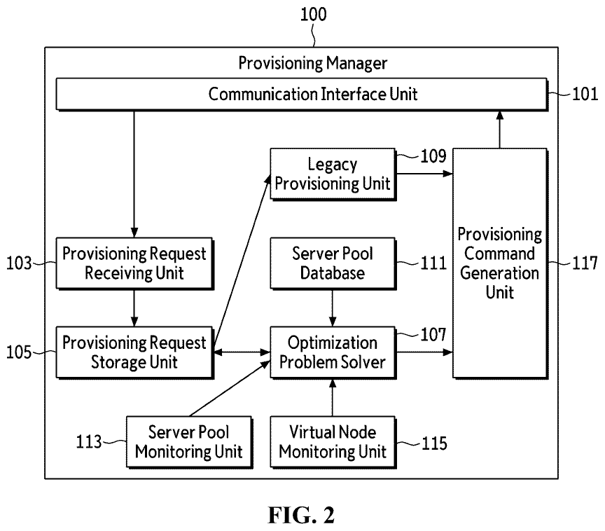

The configuration of a provisioning manager 100, according to an embodiment of the present disclosure, is described with reference to FIG. 2.

FIG. 2 is a block diagram of a provisioning manager 100, according to an embodiment of the present disclosure.

Referring to FIG. 2, the provisioning manager 100 may include a communication interface unit 101, a provisioning request receiving unit 103, a provisioning request storage unit 105, an optimization problem solver 107, a legacy provisioning unit 109, a server pool database 111, a server pool monitoring unit 113, a virtual node monitoring unit 115, and a provisioning command generation unit 117.

The communication interface unit 101 may be connected to a network and may mediate data transmission and/or reception. For example, the communication interface unit 101 may be and/or may include a virtual network interface card (vNIC).

The provisioning request receiving unit 103 may receive a provisioning request via the communication interface unit 101 and may store the received provisioning request in the provisioning request storage unit 105. The provisioning request storage unit 105 may include a queue for temporarily storing unprocessed provisioning requests and a database for storing information on processed provisioning requests.

A provisioning request inserted into the queue may be dequeued and provided to the legacy provisioning unit 109 and the optimization problem solver 107. The provisioning request may be a request for provisioning a service provisioning node. The service provisioning node may include compute nodes and/or special-purpose virtual nodes other than compute nodes.

The optimization problem solver 107 may provide identification information of provisioning target hosts for compute nodes and specification information of the compute nodes to a provisioning command generation unit 117 so that a virtual node provisioning command for the compute nodes may be generated. The specification information of the compute nodes may be derived from information of the provisioning request and may include, for example, the number of central processing unit (CPU) cores, CPU core performance, memory capacity, and storage capacity of virtual machines. However, embodiments of the present disclosure are not limited in this regard.

The legacy provisioning unit 109 may provide identification information of provisioning target hosts for special-purpose virtual nodes and/or specification information of the special-purpose virtual nodes to the provisioning command generation unit 117 so that a virtual node provisioning command for the special-purpose virtual nodes may be generated. The legacy provisioning unit 109 may determine a provisioning target host for each type of special-purpose virtual node using predefined rules specific to each type of special-purpose virtual node.

The provisioning command generation unit 117 may generate a virtual node provisioning command interpretable by middleware, such as, but not limited to, hypervisors installed on hosts in a server pool 200, using the specification information of the virtual nodes and the identification information of the provisioning target hosts provided by the legacy provisioning unit 109 and/or the optimization problem solver 107. The provisioning command generation unit 117 may transmit the generated virtual node provisioning command to the server pool 200 via the communication interface unit 101.

In an embodiment, the optimization problem solver 107 may not determine provisioning target hosts for all virtual nodes included in the service provisioning node. In such an embodiment, the optimization problem solver 107 may determine provisioning target hosts only for compute nodes within the service provisioning node. In some embodiments, provisioning locations for a first type of virtual nodes in the service provisioning node may be determined by the optimization problem solver 107, and provisioning locations for other types of virtual nodes in the service provisioning node may be determined by the legacy provisioning unit 109 using legacy provisioning rules. In some embodiments, provisioning optimization target nodes may be limited to compute nodes.

The optimization problem solver 107, as a module of the provisioning manager 100, may calculate the optimal solution of an objective function by receiving decision variables representing the provisioning locations of the provisioning optimization target nodes within the server pool 200. The decision variables may form a set x expressed by an equation similar to Equation 1.

$$π = \{ {S}_{x , y}^{a , b , c} \} \qquad [ Equation 1 ]$$

Here,

$${S}_{x , y}^{a , b , c}$$

may be set to one (1) if a y-th virtual node of an x-th service is provisioned on a c-th host in a b-th rack of an a-th availability zone (AZ), and may be set to zero (0) otherwise. However, embodiments of the present disclosure are not limited in this regard, and other values may be used.

The x-th service may correspond one-to-one with a provisioning request and therefore may also correspond one-to-one with the service provisioning node requested in the provisioning request. In Equation 1, x, y, a, b, and c may vary over all possible ranges, and thus, the set π of the decision variables may be understood as corresponding one-to-one with all possible cases of selecting provisioning target hosts for all services.

The optimization problem solver 107 may compute the value of the objective function by varying the decision variables that may represent each case of provisioning the y-th virtual node of the x-th service on each host in the server pool 200. The optimization problem solver 107 may find the decision variables that may result in an optimal solution, which may correspond to the minimum value of the objective function. Therefore, the optimization problem solver 107 may need to reference information on how the hosts are structured in the server pool 200, as such reference information may vary (affect) the decision variables.

In the present disclosure, the information on how the hosts are structured in the server pool 200 may be referred to as host topology information. The optimization problem solver 107 may query the server pool database 111 that may host the host topology information to obtain data required for generating the set π of the decision variables. Using the host topology information, the optimization problem solver 107 may set a plurality of valid provisioning locations as the decision variables. The optimization problem solver 107 may set the range of valid indices of AZs, racks, and/or hosts in the server pool 200 to set the plurality of valid provisioning locations as the decision variables.

In an embodiment, the provisioning manager 100 may be physically implemented by analog and/or digital circuits including one or more of a logic gate, an integrated circuit, a microprocessor, a microcontroller, a memory circuit, a passive electronic component, an active electronic component, an optical component, and the like. For example, a field programmable gate array (FPGA) may be used to implement custom logic that may include the functionality of the provisioning manager 100. As another example, a processor in combination with a memory may be used to execute one or more instructions to perform the functionality of the provisioning manager 100. Alternatively or additionally, each of the components of the provisioning manager (e.g., the provisioning request receiving unit 103, the provisioning request storage unit 105, the optimization problem solver 107, the legacy provisioning unit 109, the server pool database 111, the server pool monitoring unit 113, the virtual node monitoring unit 115, and the provisioning command generation unit 117) may be implemented using hardware, software, or a combination thereof. In some embodiments, one or more components of the provisioning manager 100 may be implemented separately from the provisioning manager 100 (e.g., different processing hardware) and/or jointly with at least a portion of the functionality of the provisioning manager 100.

In the present disclosure, it may be assumed that each host may belong to one of multiple racks, and that each rack may belong to one of multiple AZs. That is, the server pool 200 may be structured hierarchically in a top-down manner with AZs, racks, and hosts. Referring to Equation 1, a may represent the index of an AZ in the server pool 200, b may represent the index of a rack within the a-th AZ, and c may represent the index of a host within the b-th rack. Consequently, (a, b, c) may be used as a unique identifier for a specific host in the server pool 200.

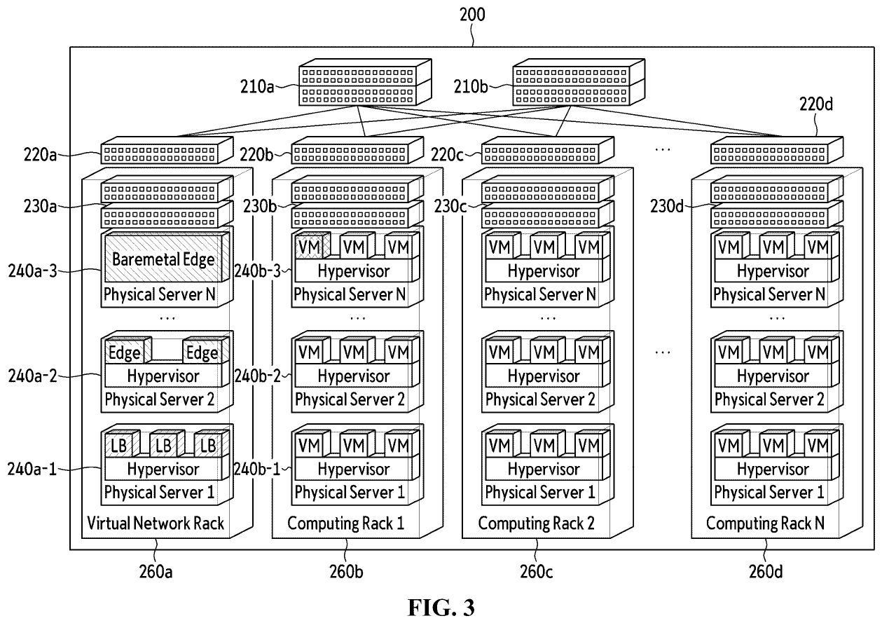

The configuration of an exemplary server pool 200, according to an embodiment of the present disclosure, is illustrated in FIG. 3. The server pool 200 in FIG. 3 may include a single AZ. Referring to FIG. 3, the server pool 200 includes a plurality of racks (e.g., a virtual network rack 260a, a first computing rack 260b, a second computing rack 260c, up to a third computing rack 260d), and each rack may contain a plurality of hosts. For example, the virtual network rack 260a may include a first virtual network host 240a-1, a second virtual network host 240a-2, to an N-th virtual network host 240a-N, and the first computing rack 260b may include a first computing host 240b-1, a second computing host 240b-2, up to an Nth computing host 240b-N.

The server pool 200 may further include switches for routing network traffic between hosts. The plurality of racks 260a to 260d may include a plurality of top-of-rack (ToR) switches (e.g., a first ToR switch 230a, a second ToR switch 230b, a third ToR switch 230c, and a fourth ToR switch 230d), respectively. The plurality of ToR switches 230a to 230d may be connected to respective leaf switches (e.g., a first leaf switch 220a, a second leaf switch 220b, a third leaf switch 220c, and a fourth leaf switch 220d). The plurality of leaf switches 220a to 220d may be connected to spine switches (e.g., a first spine switch 210a and a second spine switch 210b). The first and second spine switches 210a and 210b may be connected to an external network. Thus, the server pool 200 may include a hierarchical structure of multiple switches. Virtual nodes provisioned on the hosts within the server pool 200 may transmit and/or receive east-west traffic and north-south traffic through the aforementioned switches.

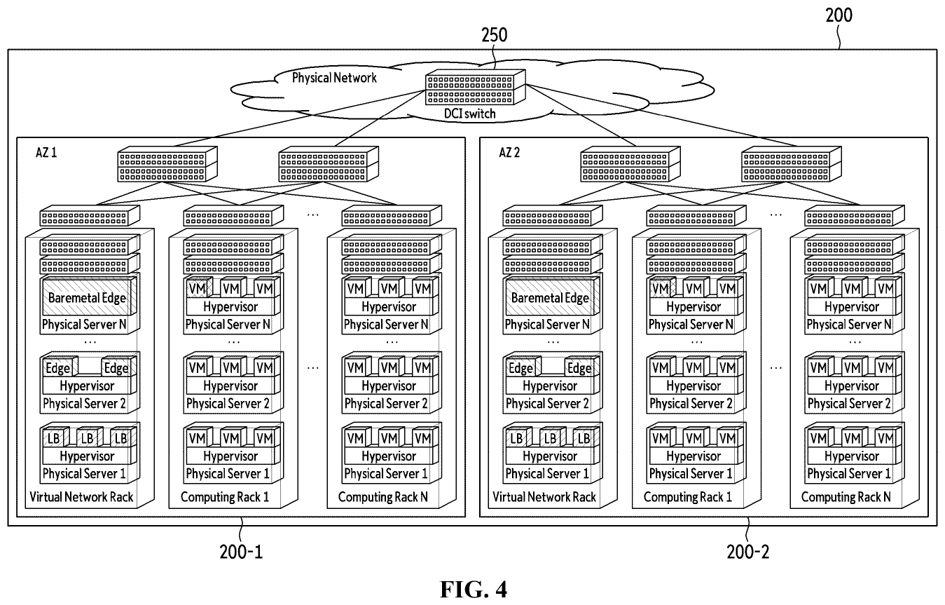

The server pool 200 may also be constructed across multiple AZs. FIG. 4 illustrates another exemplary server pool 200, which includes racks in a first AZ 200-1 and racks in a second AZ 200-2. The spine switches connected to the racks in the first AZ 200-1 and the spine switches connected to the racks in the second AZ 200-1 may be connected to each other via a data center interconnect (DCI) switch 250, and as a result, hosts in different AZs may be able to transmit and/or receive east-west traffic and north-south traffic. The DCI switch 250 may refer to a network device that may be used to implement DCI. As used herein, DCI may refer to a technology that may connect multiple data centers to efficiently share data, applications, and workloads and to support backup and disaster recovery.

In some embodiments, constraints may be imposed on how x, y, a, b, and c are varied. That is, a set π of

$${S}_{x , y}^{a , b , c}$$

values (e.g., one (1) or zero (u) values) that violates such constraints may not be input as decision variables into the objective function. Exemplary constraints are hereinafter described.

The optimization problem solver 107 may calculate the optimal solution of the objective function within a range that may satisfy high-availability constraints by ensuring that the set x of the decision variables is varied under one of the following high-availability constraints.

A first high-availability constraint may be represented as an equation similar to Equation 2.

$$For all a , {\sum }_{y} {\sum }_{b} {\sum }_{c} {S}_{x , y}^{a , b , c} < {R}_{x} \qquad [ Equation 2 ]$$

Referring to Equation 2, Rₓ may represent the number of virtual machines for the x-th service.

A second high-availability constraint may be represented as an equation similar to Equation 3.

$$For a specific b , {\sum }_{y} {\sum }_{b} {\sum }_{c} {S}_{x , y}^{a , b , c} = {R}_{x} , and \qquad [ Equation 3 ]$$

$$for all b , {\sum }_{y} {\sum }_{c} {S}_{x , y}^{a , b , c} < {R}_{x}$$

A third high-availability constraint may be represented as an equation similar to Equation 4.

$$For a specific b , {\sum }_{y} {\sum }_{b} {\sum }_{c} {S}_{x , y}^{a , b , c} = {R}_{x} , and \qquad [ Equation 4 ]$$

$$for all c , {\sum }_{y} {S}_{x , y}^{a , b , c} < {R}_{x}$$

Referring to Equations 2 to 4, the first high-availability constraint may require that service provisioning nodes must be provisioned in different AZs, the second high-availability constraint may require that service provisioning nodes must be provisioned in different racks, and the third high-availability constraint may require that service provisioning nodes must be provisioned on different hosts.

Additionally, the optimization problem solver 107 may calculate an optimal solution of the objective function within a range that may satisfy a virtual node placement host-specific constraint, which may be understood as a constraint requiring virtual nodes to be provisioned only on specific hosts.

The virtual node placement host-specific constraint may be represented as an equation similar to Equation 5.

$${\sum }_{a} {\sum }_{b} {\sum }_{c} {S}_{x , y}^{a , b , c} = 1 \qquad [ Equation 5 ]$$

The optimization problem solver 107 may also calculate the optimal solution of the objective function within a range that may satisfy a network interface card (NIC) constraint, which may stipulate that the total traffic of all virtual nodes provisioned on a single host must not exceed the bandwidth of the physical NIC.

The NIC constraint may be represented as an equation similar to Equation 6.

$${\sum }_{x} {\sum }_{y} {\sum }_{c} ( {S}_{x , y}^{a , b , c} \cdot {\sum }_{{y}^{′}} {T}_{y , {y}^{′}}^{x} ) < {P}_{N}^{a , b , c} \qquad [ Equation 6 ]$$

Referring to Equation 6,

$${P}_{N}^{a , b , c}$$

may represent the bandwidth of the NIC of the c-th host in the b-th rack of the a-th AZ.

Moreover, the optimization problem solver 107 may calculate the optimal solution of the objective function under at least one of the following over-provisioning constraints, which may require that the total resource demands of all virtual nodes provisioned on a single host must not exceed the host's resource capacity by a specified over-provisioning ratio.

A first over-provisioning constraint may be represented as an equation similar to Equation 7.

$${\sum }_{x} {\sum }_{y} {\sum }_{c} ( {S}_{x , y}^{a , b , c} \cdot {U}_{x , y} ) < {θ}_{1} \cdot {P}_{C P U}^{a , b , c} \qquad [ Equation 7 ]$$

A second over-provisioning constraint may be represented as an equation similar to Equation 8.

$${\sum }_{x} {\sum }_{y} {\sum }_{c} ( {S}_{x , y}^{a , b , c} \cdot {M}_{x , y} ) < {θ}_{2} \cdot {P}_{MEM}^{a , b , c} \qquad [ Equation 8 ]$$

Referring to Equations 7 and 8, θ₁ may represent a CPU over-provisioning ratio, θ₂ may represent a memory over-provisioning ratio, U_{x,y} may represent the CPU resource demand of the y-th virtual node of the x-th service, M_{x,y} may represent the memory resource demand of the y-th virtual node of the x-th service,

$${P}_{C P U}^{a , b , c}$$

may represent a the CPU capacity of the c-th host in the b-th rack of the a-th AZ, and

$${P}_{MEM}^{a , b , c}$$

may represent the memory capacity of the c-th host in the b-th rack of the a-th AZ.

The objective function may refer to a function that calculates underlay traffic volume based on the decision variables. The underlay traffic volume may be determined by multiplying the traffic volume between virtual nodes by the number of underlay hops between the virtual nodes. The traffic volume between the virtual nodes may be understood as referring to the overlay traffic volume.

Additionally, the underlay traffic volume may be the sum of the east-west traffic volume between provisioning optimization target nodes and the north-south traffic volume between the provisioning optimization target nodes and the external network.

An exemplary objective function may be represented as an equation similar to Equation 9.

$${min}_{π} {\sum }_{x} {\sum }_{y} {\sum }_{{y}^{′}} {\sum }_{a} {\sum }_{b} {\sum }_{c} {S}_{x , y}^{a , b , c} \cdot ( {T}_{y , {y}^{′}}^{x} \cdot {H}_{y , {y}^{′}}^{x} + {T}_{y , Edge}^{x} \cdot {H}_{y , Edge}^{x} + {T}_{y , LB}^{x} \cdot {H}_{y , LB}^{x} ) \qquad [ Equation 9 ]$$

Referring to Equation 9,

$${T}_{y , {y}^{′}}^{x}$$

may represent the traffic volume between the y-th and y′-th virtual nodes of the x-th service,

$${H}_{y , {y}^{′}}^{x}$$

may represent the number of underlay hops between the y-th and y′-th virtual nodes of the x-th service,

$${T}_{y , Edge}^{x}$$

may represent the traffic volume between the y-th virtual node of the x-th service and an edge node Edge,

$${H}_{y , Edge}^{x}$$

may represent the number of underlay hops between the y-th virtual node of the x-th service and the edge node Edge,

$${T}_{y , LB}^{x}$$

may represent the traffic volume between the y-th virtual node of the x-th service and a load balancing node LB, and

$${H}_{y , LB}^{x}$$

may represent the number of underlay hops between the y-th virtual node of the x-th service and the load balancing node LB.

Additionally, in Equation 9,

$${T}_{y , {y}^{′}}^{x} \cdot {H}_{y , {y}^{′}}^{x}$$

may represent the east-west underlay traffic volume between the y-th and y′-th virtual nodes of the x-th service. That is,

$${T}_{y , {y}^{′}}^{x} \cdot {H}_{y , {y}^{′}}^{x}$$

may be understood as being determined by multiplying the traffic volume between the two virtual nodes by the number of underlay hops between them when the y-th virtual node is provisioned at a first provisioning location in the server pool 200 and the y′-th virtual node is provisioned at a second provisioning location in the server pool 200.

The computation of

$${T}_{y , {y}^{′}}^{x} \cdot {H}_{y , {y}^{′}}^{x}$$

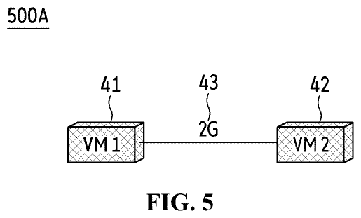

for determining the east-west underlay traffic volume is described with reference to FIGS. 5 to 9.

FIG. 5 illustrates an exemplary service provisioning node. As illustrated in FIG. 5, the service provisioning node 500A may include a first virtual machine VM1 41 and a second virtual machine VM2 42, and may be configured to generate an average of 2 gigabytes (G) of overlay traffic between the first and second virtual machines 41 and 42. This overlay traffic volume may be understood as a non-limiting example of information that may be included in a provisioning request provided by a user terminal 10. It is described below how the east-west underlay traffic volume between the first and second virtual machines 41 and 42 may vary depending on the network connections between the hosts on which the first and second virtual machines 41 and 42 are respectively provisioned.

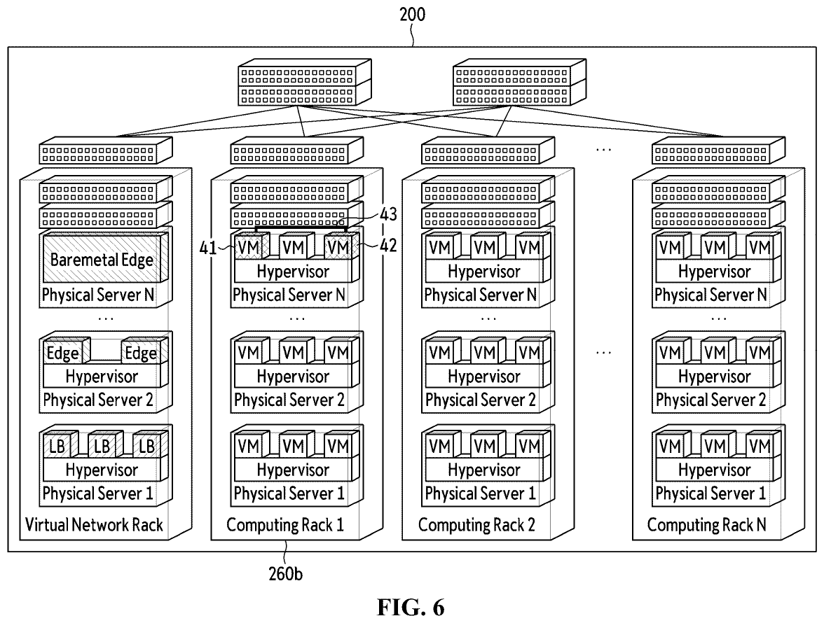

FIG. 6 illustrates a case where, according to the decision variables, the first and second virtual machines 41 and 42 are provisioned together on a specific host located in the first computing rack 260b. In this case, the underlay hop count between the first and second virtual machines 41 and 42 becomes zero (0). Therefore, the underlay traffic volume 43 between the first and second virtual machines 41 and 42 is zero (0).

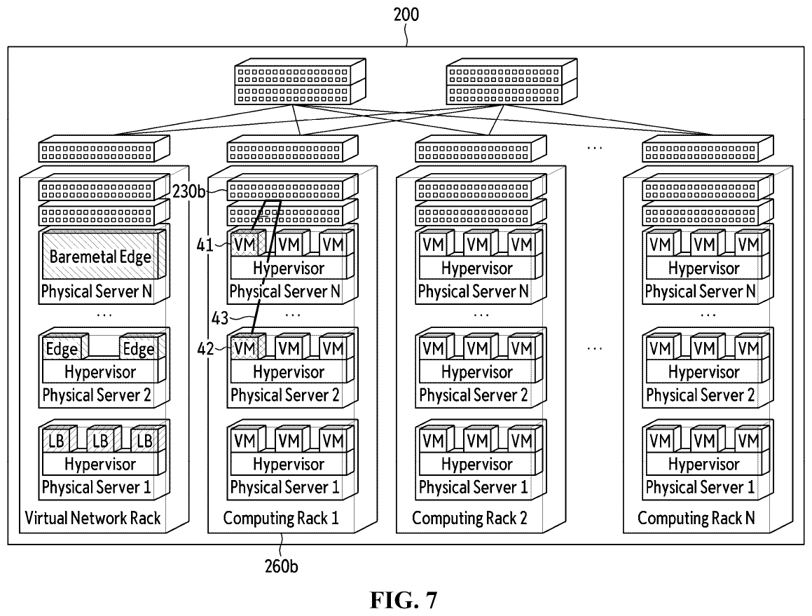

FIG. 7 illustrates a case where, according to the decision variables, the first and second virtual machines 41 and 42 are provisioned on different hosts within the first computing rack 260b. In this case, the underlay hop count between the first and second virtual machines 41 and 42 becomes two (2), including the first hop from the first virtual machine 41 to the ToR switch 230b and the second hop from the ToR switch 230b to the second virtual machine 42. Therefore, the underlay traffic volume 43 between the first and second virtual machines 41 and 42 becomes 4G (e.g., 2×2G).

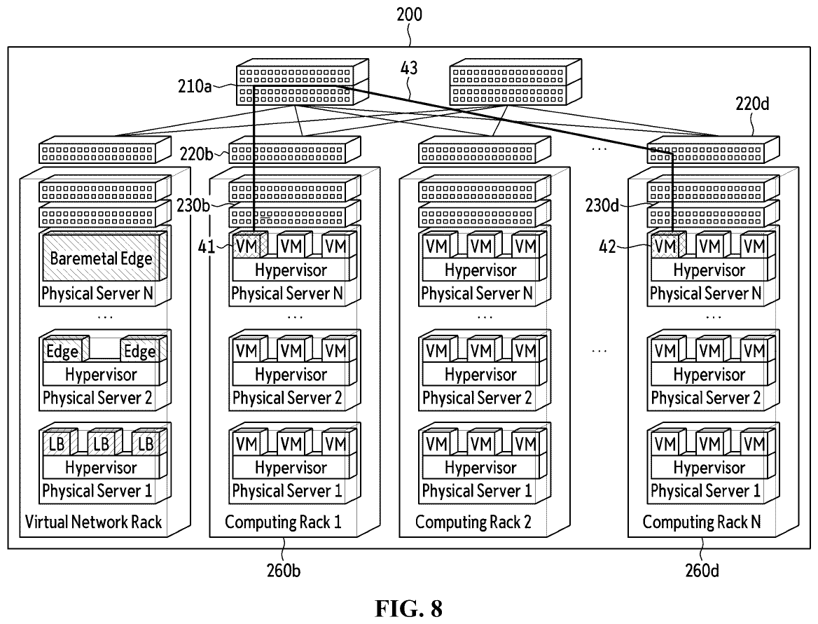

FIG. 8 illustrates a case where, according to the decision variables, the first virtual machine 41 is provisioned on a host located in the first computing rack 260b and the second virtual machine 42 is provisioned on a host located in the N-th computing rack 260d. In this case, the underlay hop count between the first and second virtual machines 41 and 42 becomes six (6), including the first hop from the first virtual machine 41 to the second ToR switch 230b, the second hop from the second ToR switch 230b to the second leaf switch 220b, the third hop from the second leaf switch 220b to the first spine switch 210a, the fourth hop from the first spine switch 210a to the fourth leaf switch 220d, the fifth hop from the fourth leaf switch 220d to the fourth ToR switch 230d, and the sixth hop from the fourth ToR switch 230d to the second virtual machine 42. Therefore, the underlay traffic volume 43 between the first and second virtual machines 41 and 42 becomes 12G (e.g., 6×2G).

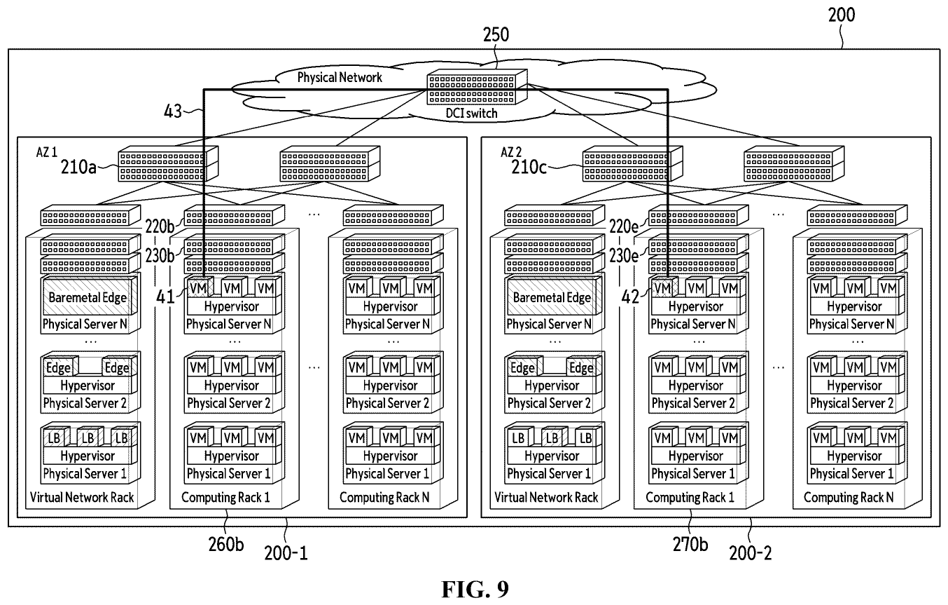

FIG. 9 illustrates a case where, according to the decision variables, the first and second virtual machines 41 and 42 are provisioned on hosts located in different availability zones AZs. As shown in FIG. 9, the first virtual machine 41 is provisioned on a host in the first computing rack 260b of the first AZ 200-1, and the second virtual machine 42 is provisioned on a host in the first computing rack 270b of the second AZ 200-2. In this case, the underlay hop count between the first and second virtual machines 41 and 42 becomes eight (8), including the first hop from the first virtual machine 41 to the second ToR switch 230b, the second hop from the second ToR switch 230b to the second leaf switch 220b, the third hop from the second leaf switch 220b to the first spine switch 210a, the fourth hop from the first spine switch 210a to the DCI switch 250, the fifth hop from the DCI switch 250 to a third spine switch 210c, the sixth hop from the third spine switch 210c to a second leaf switch 220e, the seventh hop from the second leaf switch 220e to the second ToR switch 230e, and the eighth hop from the second ToR switch 230e to the second virtual machine 42. Additionally, the area outside the first and second AZs 200-1 and 200-2 may be a physical network area, and a number a of hops in this physical network area additional hops should be added to the underlay hop count of eight (8). Thus, the underlay traffic volume 43 between the first and second virtual machines 41 and 42 becomes (16+2α) G (e.g., (8+α)×2G). The number a of hops in the physical network area may be a predefined value and/or may extracted from information included in network packets.

A formula summarizing the setting of the east-west underlay hop count

$$( e . g . , {H}_{{y}^{′} {y}^{′}}^{x} )$$

between the first and second virtual machines 41 and 42 based on the network connections of the hosts on which the first and second virtual machines 41 and 42 are respectively provisioned, as described with reference to FIGS. 6 to 9, is provided in Equation 10 below. As specified in Equation 10, the setting of the underlay hop count

$$( e . g . , {H}_{{y}^{′} {y}^{′}}^{x} )$$

between the first and second virtual machines 41 and 42 is only meaningful when the overlay traffic volume

$$( e . g . , {T}_{y , {y}^{′}}^{x} )$$

exists between the first and second virtual machines 41 and 42.

$$Only if {S}_{x , y}^{a , b , c} = {S}_{x , {y}^{′}}^{{a}^{′} , {b}^{′} , {c}^{′}} = 1 and {T}_{y , {y}^{′}}^{x} > 0 , then {H}_{y , {y}^{′}}^{x} exists . \qquad [ Equation 10 ]$$

$$Case 1 ) a = {a}^{′} , b = {b}^{′} , and c = {c}^{′} →︀ {H}_{y , {y}^{′}}^{x} = 0$$

$$Case 2 ) a = {a}^{′} , b = {b}^{′} , and c \neq {c}^{′} →︀ {H}_{y , {y}^{′}}^{x} = 2$$

$$Case 3 ) a = {a}^{′} and b \neq {b}^{′} →︀ {H}_{y , {y}^{′}}^{x} = 6$$

$$Case 4 ) a \neq {a}^{′} →︀ {H}_{y , {y}^{′}}^{x} = 8 + α$$

Referring to Equation 10, a may represent the given number of hops in the physical network.

Referring back to Equation 9,

$${T}_{y , E d g e}^{x} \cdot {H}_{y , Edge}^{x} + {T}_{y , L B}^{x} \cdot {H}_{y , L B}^{x}$$

may represent the north-south underlay traffic volume generated by the y-th virtual node. This north-south underlay traffic volume may be understood as the sum of a first north-south traffic volume determined by multiplying the underlay hop count between the first virtual machine 41 and the edge node Edge by the traffic volume between the first virtual machine 41 and the edge node Edge when the first virtual machine 41 is provisioned at a first provisioning location in the server pool 200, and a second north-south traffic volume determined by multiplying the underlay hop count between the first virtual machine 41 and the load balancing node LB by the traffic volume between the first virtual machine 41 and the load balancing node LB.

The computation of

$${T}_{y , {y}^{′}}^{x} \cdot {H}_{y , {y}^{′}}^{x}$$

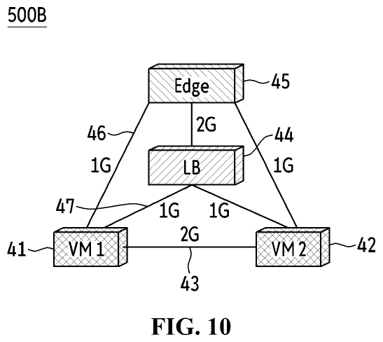

for determining the north-south underlay traffic volume is described with reference to FIGS. 10 to 14.

FIG. 10 illustrates another exemplary service provisioning node. Referring to FIG. 10, the service provision node 500B may include and/or may be similar in many respects to the service provision node 500B described above with reference to FIG. 5, and may include additional features not mentioned above. Consequently, repeated descriptions of the service provision node 500B described above with reference to FIG. 5 may be omitted for the sake of brevity.

As illustrated in FIG. 10, the service provisioning node 500B may include a first virtual machine VM1 41, a second virtual machine VM2 42, a load balancing (LB) node 44, and an edge node 45. The edge node 45, may also be referred to as a border gateway, and may serve as a gateway for packets transitioning from the overlay section within the AZ to the underlay section outside the AZ. The load balancing node 44 may perform load balancing for packets entering the service provisioning node 500B, from among a plurality of compute nodes or virtual machines.

The service provisioning node 500B may be configured to generate an average of 2G of overlay traffic between the first and second virtual machines 41 and 42, an average of 1G of overlay traffic between the first virtual machine 41 and the load balancing node 44, an average of 1G of overlay traffic between the second virtual machine 42 and the load balancing node 44, and an average of 2G of overlay traffic between the load balancing node 44 and the edge node 45. These overlay traffic volumes may be understood as non-limiting examples of information that may be included in a provisioning request provided by a user terminal.

As previously described,

$${T}_{y , Edge}^{x} \cdot {H}_{y , Edge}^{x} + {T}_{y , LB}^{x} \cdot {H}_{y , LB}^{x}$$

may refer to the north-south underlay traffic volume generated by the y-th virtual node. When the y-th virtual node is the first virtual machine 41 in FIG. 10, the north-south overlay traffic of the first virtual machine 41 may include first path traffic 47 passing through the edge node 45 and the load balancing node 44 to reach the first virtual machine 41, and second path traffic 46 reaching the first virtual machine 41 directly from the edge node 45. In the first path traffic 47, the section between the edge node 45 and the load balancing node 44 may be a fixed section, and as the edge node 45 and the load balancing node 44 are typically placed adjacent to each other in physical resources, the first path traffic 47 may be replaced by the traffic volume between the first virtual machine 41 and the load balancing node 44. Therefore,

$${T}_{y , Edge}^{x} \cdot {H}_{y , Edge}^{x}$$

may be understood as referring to the underlay traffic volume of the second path traffic 46, and

$${T}_{y , LB}^{x} \cdot {H}_{y , LB}^{x}$$

may be understood as referring to the underlay traffic volume of the first path traffic 47.

It is described below how the north-south underlay traffic volume of the first virtual machine 41 varies depending on the network connections between the host on which the first virtual machine 41 is provisioned and the edge node 45 or the load balancing node 44.

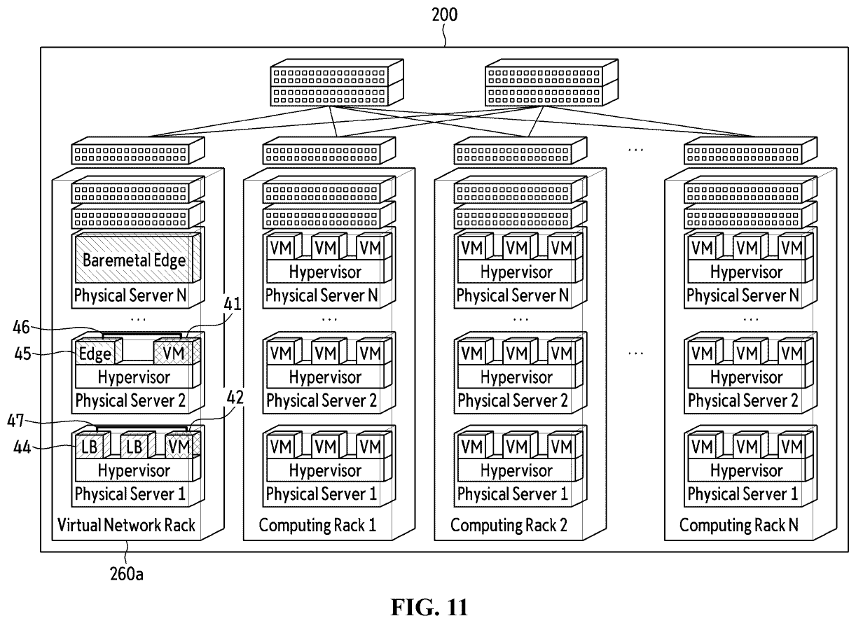

FIG. 11 illustrates a case where, according to the decision variables, virtual machines 41 and 42 are provisioned together on a specific host located in the virtual network rack 260a. In this case, the underlay hop counts between the first virtual machine 41 and the edge node 45 and between the second virtual machine 42 and the load balancing node 44 are both zero (0). Therefore, the north-south underlay traffic volume generated by virtual machines 41 and 42 is zero (0).

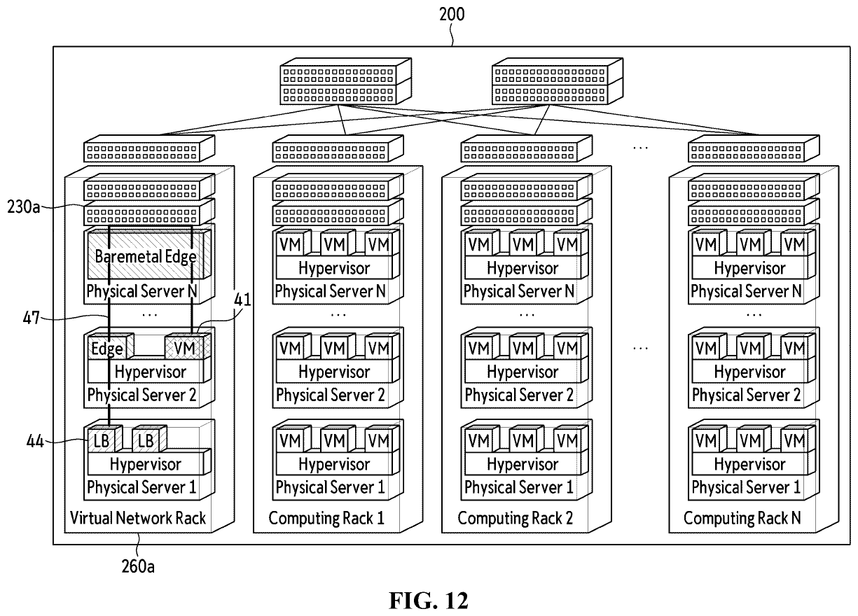

FIG. 12 illustrates a case where, according to the decision variables, the first virtual machine 41 and the load balancing node 44 are provisioned on different hosts within the virtual network rack 260a. In this case, the underlay hop count between the first virtual machine 41 and the load balancing node 44 may total two (2), including the first hop from the first virtual machine 41 to the first ToR switch 230a and the second hop from the first ToR switch 230a to the load balancing node 44. Therefore, the underlay traffic volume 47 between the first virtual machine 41 and the load balancing node 44 becomes 4G (e.g., 2×2G).

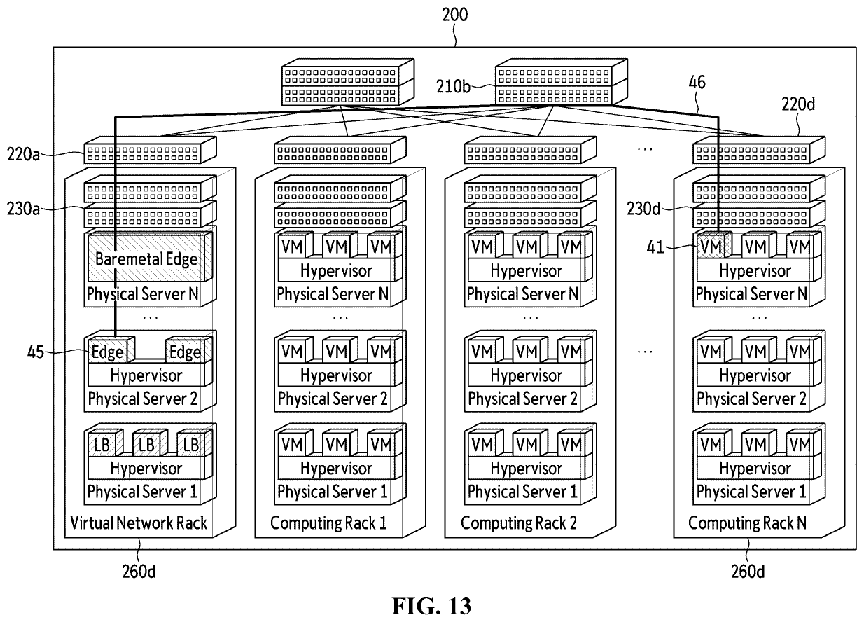

FIG. 13 illustrates a case where, according to the decision variables, the first virtual machine 41 and the edge node 45 are provisioned on hosts located in the N-th computing rack 260d and the virtual network rack 260a, respectively. In this case, the underlay hop count between the first virtual machine 41 and the edge node 45 totals six (6), including the first hop from the first virtual machine 41 to the fourth ToR switch 230d, the second hop from the fourth ToR switch 230d to the fourth leaf switch 220d, the third hop from the fourth leaf switch 220d to the second spine switch 210b, the fourth hop from the second spine switch 210b to the first leaf switch 220a, the fifth hop from the first leaf switch 220a to the first ToR switch 230a, and the sixth hop from the first ToR switch 230a to the edge node 45. Therefore, the underlay traffic volume 46 between the first virtual machine 41 and the edge node 45 becomes 12G (e.g., 6×2G).

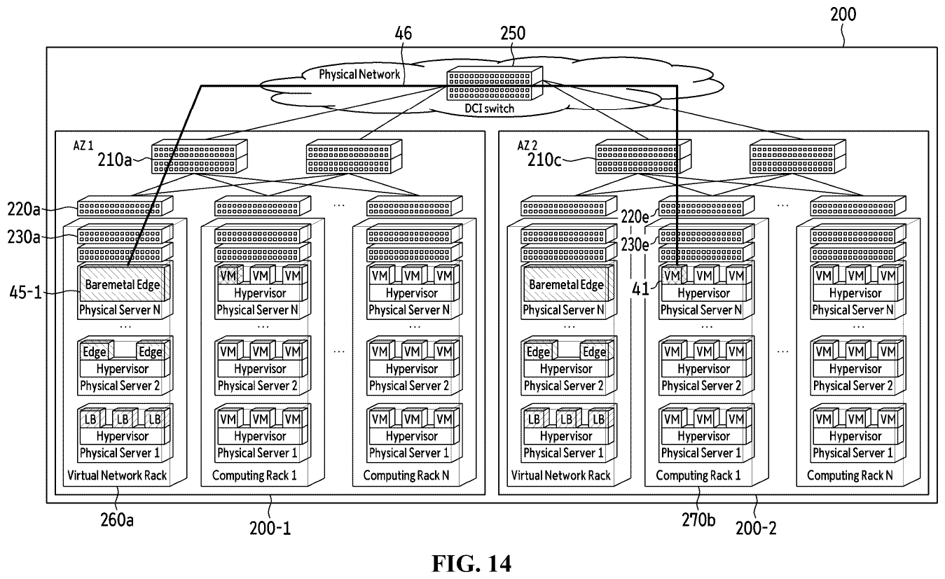

FIG. 14 illustrates a case where, according to the decision variables, the first virtual machine 41 and the edge node 45-1 are provisioned on hosts located in different AZs. As shown in FIG. 14, the first virtual machine 41 is provisioned on a host in the first computing rack 270b of the second AZ 200-2, and the edge node 45-1 is provisioned on a host in the virtual network rack 260a of the first AZ 200-1. In this case, the underlay hop count between the first virtual machine 41 and the edge node 45-1 totals eight (8), including the first hop from the first virtual machine 41 to the second ToR switch 230e, the second hop from the second ToR switch 230e to the second leaf switch 220e, the third hop from the second leaf switch 220e to the first spine switch 210c, the fourth hop from the first spine switch 210c to the DCI switch 250, the fifth hop from the DCI switch 250 to the first spine switch 210a, the sixth hop from the first spine switch 210a to the first leaf switch 220a, the seventh hop from the first leaf switch 220a to the first ToR switch 230a, and the eighth hop from the first ToR switch 230a to the edge node 45-1. Additionally, the area outside the first and second AZs 200-1 and 200-2 may be a physical network area, and the number a of hops in this physical network area must be added to the underlay hop count of eight (8). Thus, the underlay traffic volume 46 between the first virtual machine 41 and the edge node 45-1 becomes (16+2α) G (e.g., (8+α)×2G). The number a of hops in the physical network area may be a predefined value and/or may be extracted from information included in network packets.

The formulas summarizing the setting of the north-south underlay hop counts

$$( e . g . , {H}_{y , Edge}^{x} and {H}_{y , LB}^{x} )$$

between the host on which the first virtual machine 41 is provisioned and the edge node 45 or the load balancing node 44 based on the network connections described in FIGS. 11 to 14, are presented as Equations 11 and 12 below. As indicated by Equation 11 below, the setting of the underlay hop count

$$( e . g . , {H}_{y , Edge}^{x} )$$

between the first virtual machine 41 and the edge node Edge may be meaningful only when the overlay traffic volume

$$( e . g . , {T}_{y , Edge}^{x} )$$

exists between the first virtual machine 41 and the edge node Edge. Similarly, as indicated by Equation 12 below, the setting of the underlay hop count between the first virtual machine 41 and the load balancing node LB

$$( e . g . , {H}_{y , LB}^{x} )$$

is meaningful only when the overlay traffic volume

$$( e . g . , {T}_{y , LB}^{x} )$$

exists between the first virtual machine 41 and the load balancing node LB.

$$Only if {S}_{x , y}^{a , b , c} \cdot {T}_{y , Edge}^{x} > 0 a , then {H}_{y , Edge}^{x} exists . \qquad [ Equation 10 ]$$

$$Case 1 ) a = {E}_{1} , b = {E}_{2} , and c = {E}_{3} \to {H}_{y , Edge}^{x} = 0$$

$$Case 2 ) a = {E}_{1} , b = {E}_{2} , and c \neq {E}_{3} \to {H}_{y , Edge}^{x} = 2$$

$$Case 3 ) a = {E}_{1} and b \neq {E}_{2} \to {H}_{y , Edge}^{x} = 6$$

$$Case 4 ) a \neq {E}_{1} \to {H}_{y , Edge}^{x} = 8 + α$$

Referring to Equation 11, α may represent the given number of hops in the physical network.

$$Only if {S}_{x , y}^{a , b , c} \cdot {T}_{y , LB}^{x} > 0 a , then {H}_{y , LB}^{x} exists . \qquad [ Equation 12 ]$$

$$Case 1 ) a = {L}_{1} , b = {L}_{2} , and c = {L}_{3} \to {H}_{y , LB}^{x} = 0$$

$$Case 2 ) a = {L}_{1} , b = {L}_{2} , and c \neq {L}_{3} \to {H}_{y , LB}^{x} = 2$$

$$Case 3 ) a = {L}_{1} and b \neq {L}_{2} \to {H}_{y , LB}^{x} = 6$$

$$Case 4 ) a \neq {L}_{1} \to {H}_{y , LB}^{x} = 8 + α$$

Referring to Equation 11, α may represent the given number of hops in the physical network.

Referring again to FIG. 2, in some embodiments, the optimization problem solver 107 may perform the operation of determining the provisioning target hosts for the provisioning optimization target nodes based on the provisioning request not only when the provisioning request is provided from the queue of the provisioning request storage unit 105 but also in response to the occurrence of a predefined event.

For example, the optimization problem solver 107 may perform the operation of determining the provisioning target hosts for the provisioning optimization target nodes in response to the occurrence of an event as a result of monitoring at least one service provisioning node currently operating by being provisioned in the server pool 200.

As another example, if an event occurs in a service provisioning node including first through N-th virtual nodes that are all compute nodes, and the event is triggered when the east-west underlay traffic exceeds a threshold, the optimization problem solver 107 may select the top M provisioning optimization target nodes (where M is a positive integer less than N) based on the amount of east-west underlay traffic generated and determine new provisioning target hosts for the selected provisioning optimization target nodes. The ratio of compute nodes selected as provisioning optimization target nodes to the total number of compute nodes in the service provisioning node may increase as the amount by which the east-west underlay traffic exceeds the threshold increases.

In a case where provisioning target hosts are determined in response to the occurrence of an event as a result of monitoring the service provisioning node, the optimization problem solver 107 may reduce the computational workload involved in determining the provisioning target hosts by selecting only some compute nodes within the service provisioning node as provisioning optimization target nodes.

To determine the occurrence of an event, east-west underlay traffic or both east-west underlay traffic and north-south underlay traffic may be monitored. That is, east-west underlay traffic may have a higher monitoring priority than north-south underlay traffic. For east-west underlay traffic, a significant reduction in traffic may be achieved by re-provisioning two compute nodes that generate concentrated east-west underlay traffic to lower their underlay hop count. Conversely, to reduce the north-south underlay traffic, the underlay hot counts between compute nodes and load balancing nodes or between compute nodes and edge nodes need to be reduced. However, since the provisioning target hosts for load balancing nodes and edge nodes are often constrained, achieving meaningful reductions north-south underlay traffic may be challenging for the optimization problem solver 107.

In some embodiments, the optimization problem solver 107 may determine whether an event has occurred. For example, the optimization problem solver 107 may receive physical resource monitoring results from the server pool monitoring unit 113, which may monitor the physical resources in the server pool 200, and virtual node monitoring results from the virtual node monitoring unit 115, which may monitor each virtual node provisioned in the server pool 200. As used herein, the physical resources may be understood as the individual physical computing devices constituting the server pool 200.

The operation of the provisioning manager 100 has been described with reference to FIG. 1, focusing on the operation of the virtual node provisioning system 2000, according to an embodiment of the present disclosure. The operating method of the virtual node provisioning system 2000 disclosed herein may be more thoroughly understood with reference to other embodiments to be described later. Furthermore, the technical ideas understood through the aforementioned embodiments of the virtual node provisioning system 2000 may also be reflected in the other embodiments to be described later, even if not explicitly stated.

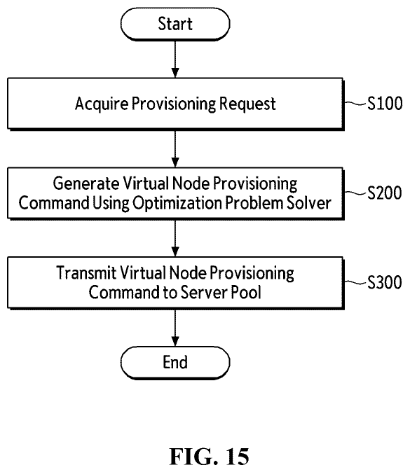

A virtual node provisioning method, according to an embodiment of the present disclosure, is described with reference to FIGS. 15 to 17. The virtual node provisioning method, according to an embodiment of the present disclosure, may be performed by at least one computing system (e.g., virtual node provisioning system 2000). In the following description, if the subject performing a specific operation is omitted, it may be understood that the specific operation may be performed by the at least one computing system. Additionally, some operations of the virtual node provisioning method, according to an embodiment of the present disclosure, may be performed by a first computing device, and the remaining operations may be performed by a second computing device. For example, some operations of the dynamic monitoring method, according to an embodiment of the present disclosure, may be performed by an on-premise physical server, while the remaining operations may be performed by a cloud compute instance.

Referring to FIG. 15, the virtual node provisioning method may include, in operation S100, acquiring a provisioning request. The provisioning request may be acquired by the provisioning manager 100 from a user terminal 10.

In operation S200, a provisioning command for virtual nodes corresponding to the provisioning request may be generated using an optimization problem solver 107.

In operation S300, the virtual node provisioning command may be transmitted to a server pool 200.

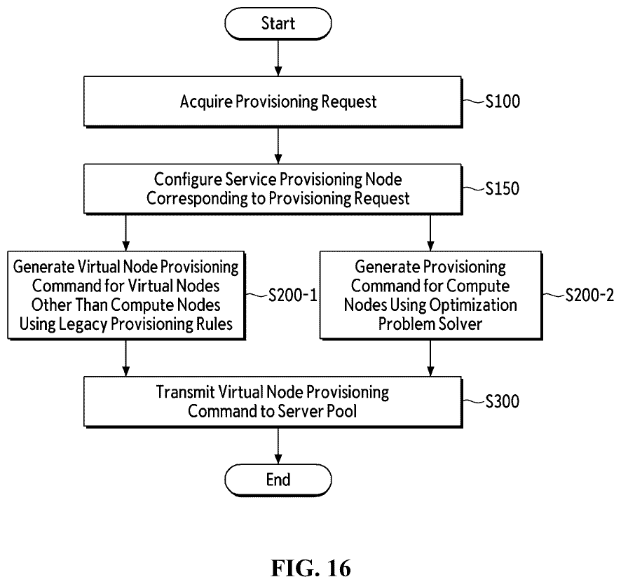

Thereafter, referring to FIG. 16, a service provisioning node corresponding to the obtained provisioning request from operation S100 may be configured (operation S150). Virtual nodes other than compute nodes included in the service provisioning node may be provisioned using legacy provisioning rules (operation S200-1), and a provisioning command for compute nodes included in the service provisioning node may be generated using the optimization problem solver 107 (operation S200-2). In operation S300, the virtual node provisioning command may be transmitted to the server pool 200.

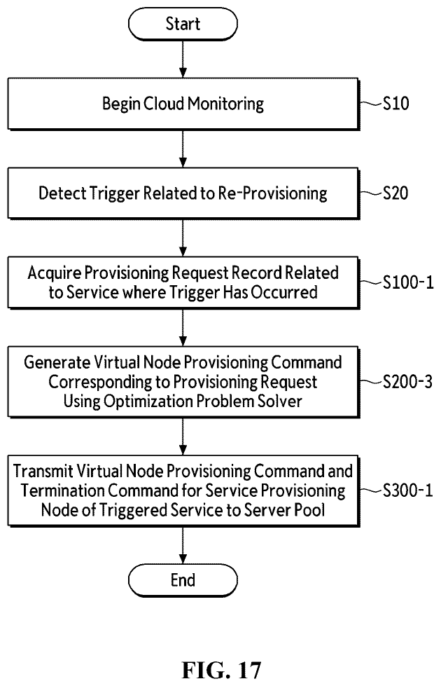

Thereafter, referring to FIG. 17, when cloud monitoring begins (operation S10), it may be determined whether a trigger has occurred that necessitates re-provisioning based on the results of the cloud monitoring (operation S20). For example, as described above, the trigger may be the exceedance of a threshold by the east-west underlay traffic generated by the service provisioning node.

If the trigger occurs, the provisioning request record associated with the triggered service may be obtained (operation S100-1). Thereafter, a provisioning command for the virtual nodes corresponding to the record of the obtained provisioning request may be generated using the optimization problem solver (S200-3). Thereafter, the virtual node provisioning command and a termination command for the service provisioning node of the service where the trigger has occurred may be transmitted to the server pool 200, enabling the service provisioning node of the service where the trigger has occurred to be re-provisioned to a new location.

The technical ideas understood through the embodiments described with reference to FIGS. 1 to 17 may also be reflected in other embodiments to be described later, even if not explicitly stated.

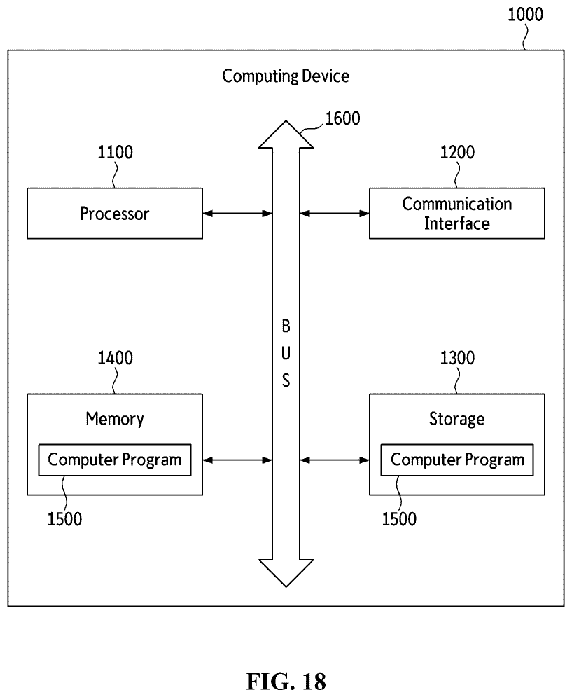

FIG. 18 illustrates an example of a hardware configuration of a computing system 1000, according to some embodiments of the present disclosure. The computing system 1000 may refer to, for example, the provisioning manager 100 described with reference to FIG. 1. The computing system 1000 may include at least one processor 1100, a system bus 1600, a communication interface 1200, a memory 1400 that may load a computer program 1500 executed by the processor 1100, and a storage 1300 that may store the computer program 1500. The computing system 1000 may be provisioned via a cloud service, in which case, the processor 1100, the communication interface 1200, the memory 1400, and the storage 1300 may all be virtualized resources.

The processor 1100 controls the overall operation of each component of the computing system 1000. The processor 1100 may perform computation for at least one application or program to execute methods/operations, according to various embodiments of the present disclosure. The memory 1400 may store various data, commands, and/or information. To execute the methods and/or operations, according to various embodiments of the present disclosure, the memory 1400 may load at least one computer program 1500 from the storage 1300. The system bus 1600 may facilitate communication between the components of the computing system 1000. The communication interface 1200 may support internet communication for the computing system 1000. The storage 1300 may non-transitorily store at least one computer program 1500.

Additionally, the storage 1300 may store configuration data for performing dynamic monitoring. The configuration data may include various dynamic monitoring-related settings, such as monitoring intervals for monitoring levels.

The computer program 1500 may include one or more instructions that implement the methods and/or operations, according to various embodiments of the present disclosure. When the computer program 1500 is loaded into the memory 1400, the processor 1100 may execute the instructions to perform the methods and/or operations, according to various embodiments of the present disclosure.

The computer program 1500 may include instructions for obtaining a provisioning request for a service provisioning node including a plurality of virtual nodes, instructions for generating a virtual node provisioning command corresponding to the obtained provisioning request using an optimization problem solver, and instructions for transmitting the virtual node provisioning command to a server pool that includes hosts where the virtual nodes are to be provisioned. The instructions for generating the provisioning command may include instructions for iteratively computing output values of an objective function that receives decision variables representing provisioning locations in the server pool for provisioning optimization target nodes included in the service provisioning node, while varying the decision variables, to determine the optimal solution of the objective function, instructions for obtaining the optimal solution of the objective function and the optimal decision variables that produce the optimal solution, as a result of the iterative computation, and instructions for generating the virtual node provisioning command using the optimal decision variables.

The objective function may refer to a function that may calculate the underlay traffic volume when the provisioning optimization target nodes are provisioned at their respective provisioning locations. The underlay traffic volume may be the sum of the east-west traffic volume between the provisioning optimization target nodes and the north-south traffic volume between the provisioning optimization target nodes and an external network.

While this invention has been described with reference to illustrative embodiments, this description is not intended to be construed in a limiting sense. Various modifications and combinations of the illustrative embodiments, as well as other embodiments of the invention, may be apparent to persons skilled in the art upon reference to the description. It is therefore intended that the appended claims encompass any such modifications or embodiments.

What is claimed is:

1. A virtual node provisioning system, comprising:
a server pool comprising a plurality of hosts, the server pool being configured to provision, based on a virtual node provisioning command, a service provisioning node on one or more hosts of the plurality of hosts, the service provisioning node comprising a plurality of virtual nodes; and
a provisioning management device comprising:
one or more processors comprising processing circuitry; and
a memory storing instructions,
wherein the instructions, when executed by the one or more processors individually or collectively, cause the provisioning management device to:
receive a provisioning request for the service provisioning node;
obtain decision variables representing provisioning locations in the server pool for provisioning optimization target nodes comprised in the plurality of virtual nodes of the service provisioning node;
compute, based on the decision variables, a solution of an objective function that minimizes an underlay traffic volume of the provisioning optimization target nodes being provisioned at the provisioning locations, the underlay traffic volume comprising a sum of an east-west traffic volume between the provisioning optimization target nodes and a north-south traffic volume between the provisioning optimization target nodes and an external network;
generate, based on the solution of the objective function, the virtual node provisioning command corresponding to the provisioning request; and
transmit, to the server pool, the virtual node provisioning command.

2. The virtual node provisioning system of claim 1, wherein the provisioning optimization target nodes comprise a first virtual node and a second virtual node, and
wherein the instructions, when executed by the one or more processors individually or collectively, cause the provisioning management device to:
determine the east-west traffic volume of the provisioning optimization target nodes based on a product of a number of underlay hops between the first virtual node and the second virtual node and a traffic volume between the first virtual node and the second virtual node, the first virtual node being provisioned at a first provisioning location in the server pool, and the second virtual node being provisioned at a second provisioning location in the server pool.

3. The virtual node provisioning system of claim 2, wherein the instructions, when executed by the one or more processors individually or collectively, cause the provisioning management device to:
determine the number of underlay hops to be a first value, based on the first virtual node and the second virtual node being provisioned on a same host;
determine the number of underlay hops to be a second value, based on the first virtual node and the second virtual node being provisioned on different hosts in a same rack;
determine the number of underlay hops to be a third value, based on the first virtual node and the second virtual node being provisioned on different racks in a same availability zone (AZ);
determine the number of underlay hops to be a fourth value, based on the first virtual node and the second virtual nodes being provisioned in different AZs,
wherein the second value is greater than the first value,
wherein the third value is greater than the second value,
wherein the fourth value is greater than the third value, and
wherein the fourth value is based on a number of hops in the external network.

4. The virtual node provisioning system of claim 2, wherein the provisioning request comprises information indicating the traffic volume between the first virtual node and the second virtual node.

5. The virtual node provisioning system of claim 1, wherein the service provisioning node further includes a load balancing node and an edge node,
wherein the provisioning optimization target nodes include a first virtual node provisioned at a first provisioning location in the server pool, and
wherein the instructions, when executed by the one or more processors individually or collectively, cause the provisioning management device to:
determine a first north-south traffic volume based on a product of a first number of underlay hops between the first virtual node and the edge node and a first traffic volume between the first virtual node and the edge node;
determine a second north-south traffic volume based on a product of a second number of underlay hops between the first virtual node and the load balancing node and a second traffic volume between the first virtual node and the load balancing node; and
determine the north-south traffic volume based on a sum of the first north-south traffic volume and the second north-south traffic volume.

6. The virtual node provisioning system of claim 5, wherein the provisioning request comprises information indicating the first traffic volume between the first virtual node and the edge node and the second traffic volume between the first virtual node and the load balancing node.

7. The virtual node provisioning system of claim 5, wherein the instructions, when executed by the one or more processors individually or collectively, cause the provisioning management device to:
determine the first number of underlay hops to be a first value, based on the first virtual node and the edge node being provisioned on a same host;
determine the first number of underlay hops to be a second value, based on the first virtual node and the edge node being provisioned on different hosts in a same rack;
determine the first number of underlay hops to be a third value, based on the first virtual node and the edge node being provisioned on different racks in a same availability zone (AZ);
determine the first number of underlay hops to be a third value, based on the first virtual node and the edge node being provisioned in different AZs;
determine the second number of underlay hops to be the first value, based on the first virtual node and the load balancing node being provisioned on the same host;
determine the second number of underlay hops to be the second value, based on the first virtual node and the load balancing node being provisioned on different hosts in the same rack;
determine the second number of underlay hops to be the third value, based on the first virtual node and the load balancing node being provisioned on different racks in the same AZ;
determine the second number of underlay hops to be the fourth value, based on the first virtual node and the load balancing node being provisioned in different AZs,
wherein the second value is greater than the first value,
wherein the third value is greater than the second value,
wherein the fourth value is greater than the third value, and
wherein the fourth value is based on a number of hops in the external network.

8. The virtual node provisioning system of claim 1, wherein the provisioning management device further includes:
a server pool database configured to store host topology information of the server pool, and
wherein the instructions, when executed by the one or more processors individually or collectively, cause the provisioning management device to:
determine, based on the host topology information, a plurality of valid provisioning locations; and
add the plurality of valid provisioning locations to the decision variables.

9. The virtual node provisioning system of claim 8, wherein the instructions, when executed by the one or more processors individually or collectively, cause the provisioning management device to:
determine the decision variables to be a set π represented as:
$$π = \{ {S}_{x , y}^{a , b , c} \} ,$$
wherein
$${S}_{x , y}^{a , b , c}$$
is set to 1 based on a y-th virtual node of an x-th service being wherein
provisioned on a c-th host in a b-th rack of an a-th availability zone (AZ) and set to 0 otherwise, and
wherein the x-th service corresponds one-to-one with the provisioning request.

10. The virtual node provisioning system of claim 9, wherein the objective function is represented as:
$${min}_{π} {\sum }_{x} {\sum }_{y} {\sum }_{{y}^{′}} {\sum }_{a} {\sum }_{b} {\sum }_{c} {S}_{x , y}^{a , b , c} \cdot ( {T}_{y , {y}^{′}}^{x} \cdot {H}_{y , {y}^{′}}^{x} + {T}_{y , Edge}^{x} \cdot {H}_{y , Edge}^{x} + {T}_{y , LB}^{x} \cdot {H}_{y , L B}^{x} ) ,$$
wherein
$${T}_{y , {y}^{′}}^{x}$$
represents a traffic volume between the y-th virtual node and a y′-th virtual node of the x-th service,
wherein
$${H}_{y , {y}^{′}}^{x}$$
represents a number of underlay hops between the y-th and y′-th virtual nodes of the x-th service,
wherein
$${T}_{y , Edge}^{x}$$
represents a traffic volume between the y-th virtual node of the x-th service and an edge node,
wherein
$${H}_{y , Edge}^{x}$$
represents a number of underlay hops between the y-th virtual node of the x-th service and the edge node,
wherein
$${T}_{y , LB}^{x}$$
represents a traffic volume between the y-th virtual node of the x-th service and a load balancing node, and
wherein
$${H}_{y , LB}^{x}$$
represents a number of underlay hops between the y-th virtual node of the x-th service and the load balancing node.

11. The virtual node provisioning system of claim 10, wherein the instructions, when executed by the one or more processors individually or collectively, cause the provisioning management device to:
compute the solution of the objective function based on at least one of a first high-availability constraint, a second high-availability constraint, or a third high-availability constraint,
wherein the first high-availability constraint is represented as:
$$For all a , {\sum }_{y} {\sum }_{b} {\sum }_{c} {S}_{x , y}^{a , b , c} < {R}_{x} ,$$
wherein the second high-availability constraint is represented as:
$$For a specific b , {\sum }_{y} {\sum }_{b} {\sum }_{c} {S}_{x , y}^{a , b , c} = {R}_{x} , and$$
$$for all b , {\sum }_{y} {\sum }_{c} {S}_{x , y}^{a , b , c} < {R}_{x} ,$$
wherein the third high-availability constraint is represented as:
$$For a specific b , {\sum }_{y} {\sum }_{b} {\sum }_{c} {S}_{x , y}^{a , b , c} = {R}_{x} , and$$
$$for all c , {\sum }_{y} {S}_{x , y}^{a , b , c} < {R}_{x} , and$$
wherein Rₓ refers to a number of virtual machines for the x-th service.

12. The virtual node provisioning system of claim 10, wherein the instructions, when executed by the one or more processors individually or collectively, cause the provisioning management device to:
compute the solution of the objective function based on a virtual node placement host-specific constraint,
wherein the virtual node placement host-specific constraint is represented as:
$${\sum }_{a} {\sum }_{b} {\sum }_{c} {S}_{x , y}^{a , b , c} = 1 .$$

13. The virtual node provisioning system of claim 10, wherein the instructions, when executed by the one or more processors individually or collectively, cause the provisioning management device to:
compute the solution of the objective function based on a network interface card (NIC) constraint,
wherein the NIC constraint is represented as:
$${\sum }_{x} {\sum }_{y} {\sum }_{c} ( {S}_{x , y}^{a , b , c} \cdot {\sum }_{{y}^{′}} {T}_{y , {y}^{′}}^{x} ) < {P}_{N}^{a , b , c} ,$$
wherein
$${P}_{N}^{a , b , c}$$
represents a bandwidth of a NIC of the c-th host in the b-th rack of the a-th AZ.

14. The virtual node provisioning system of claim 10, wherein the instructions, when executed by the one or more processors individually or collectively, cause the provisioning management device to:
compute the solution of the objective function based on at least one of a first over-provisioning constraint or a second over-provisioning constraint,
wherein the first over-provisioning constraint is represented as:
$${\sum }_{x} {\sum }_{y} {\sum }_{c} ( {S}_{x , y}^{a , b , c} \cdot {U}_{x , y} ) < {θ}_{1} \cdot {P}_{CPU}^{a , b , c} ,$$
wherein the second over-provisioning constraint is represented as:
$${\sum }_{x} {\sum }_{y} {\sum }_{c} ( {S}_{x , y}^{a , b , c} \cdot {M}_{x , y} ) < {θ}_{2} \cdot {P}_{MEM}^{a , b , c} ,$$
wherein θ₁ represents a central processing unit (CPU) over-provisioning ratio,
wherein θ₂ represents a memory over-provisioning ratio,
wherein U_{x,y} represents a CPU resource demand of the y-th virtual node of the x-th service,
wherein M_{x,y} represents a memory resource demand of the y-th virtual node of the x-th service,
wherein
$${P}_{CPU}^{a , b , c}$$
represents a CPU capacity of the c-th host in the b-th rack of the a-th AZ, and
wherein
$${P}_{MEM}^{a , b , c}$$
represents a memory capacity of the c-th host in the b-th rack of the a-th AZ.

15. The virtual node provisioning system of claim 1, wherein the provisioning optimization target nodes are compute nodes.

16. The virtual node provisioning system of claim 1, wherein the instructions, when executed by the one or more processors individually or collectively, cause the provisioning management device to:
determine, using an optimization problem solver, first provisioning locations for first virtual nodes of a first type from among the plurality of virtual nodes of the service provisioning node; and
determine, using one or more legacy provisioning rules, second provisioning locations for remaining virtual nodes of another type different from the first type from among the plurality of virtual nodes.

17. A virtual node provisioning method performed by a computing system, the virtual node provisioning method comprising:
obtaining a provisioning request for a service provisioning node comprising a plurality of virtual nodes;
generating, using an optimization problem solver, a virtual node provisioning command corresponding to the provisioning request; and
provisioning the service provisioning node on one or more hosts of a plurality of hosts of a server pool by transmitting the virtual node provisioning command to the server pool comprising hosts where the plurality of virtual nodes are to be provisioned,
wherein the generating of the virtual node provisioning command comprises:
obtaining decision variables representing provisioning locations in the server pool for provisioning optimization target nodes comprised in the plurality of virtual nodes of the service provisioning node;
iteratively computing output values of an objective function, while varying the decision variables, the objective function calculating an underlay traffic volume of the provisioning optimization target nodes being provisioned at the provisioning locations, the underlay traffic volume comprising a sum of an east-west traffic volume between the provisioning optimization target nodes and a north-south traffic volume between the provisioning optimization target nodes and an external network;
determining a solution of the objective function based on a minimum of the output values of the objective function;
obtaining selected decision variables from among the decision variables corresponding to the solution; and
generating the virtual node provisioning command based on the selected decision variables.

18. The virtual node provisioning method of claim 17, further comprising:
determining the east-west traffic volume of the provisioning optimization target nodes based on a product of a first number of underlay hops between a first virtual node and a second virtual node of the service provisioning node and a first traffic volume between the first virtual node and the second virtual node, the first virtual node being provisioned at a first provisioning location in the server pool, and the second virtual nodes being provisioned at a second provisioning location in the server pool;
determining a first north-south traffic volume based on a product of a second number of underlay hops between the first virtual node and an edge node of the service provisioning node and a second traffic volume between the first virtual node and the edge node;
determining a second north-south traffic volume based on a product of a third number of underlay hops between the first virtual node and a load balancing node of the service provisioning node and a third traffic volume between the first virtual node and the load balancing node; and
determining the north-south traffic volume based on a sum of the first north-south traffic volume and the second north-south traffic volume.

19. The virtual node provisioning method of claim 18, further comprising:
determining the first number of underlay hops to be a first value, based on the first virtual node and the second virtual node being provisioned on a same host;
determining the first number of underlay hops to be a second value, based on the first virtual node and the second virtual node being provisioned on different hosts in a same rack;
determining the first number of underlay hops to be a third value, based on the first virtual node and the second virtual node being provisioned on different racks in a same availability zone (AZ);
determining the first number of underlay hops to be a fourth value based on the first virtual node and the second virtual node being provisioned in different AZs;
determining the second number of underlay hops to be the first value, based on the first virtual node and the edge node being provisioned on the same host;
determining the second number of underlay hops to be the second value, based on the first virtual node and the edge node being provisioned on different hosts in a same rack;
determining the second number of underlay hops to be the third value, based on the first virtual node and the edge node being provisioned on different racks in the same AZ;
determining the second number of underlay hops to be the fourth value, based on the first virtual node and the edge node being provisioned in different AZs;
determining the third number of underlay hops to be the first value, based on the first virtual node and the load balancing node being provisioned on the same host;
determining the third number of underlay hops to be the second value, based on the first virtual node and the load balancing node being provisioned on different hosts in the same rack;
determining the third number of underlay hops to be the third value, based on the first virtual node and the load balancing node being provisioned on different racks in the same AZ; and
determining the third number of underlay hops to be the fourth value, based on the first virtual node and the load balancing node being provisioned in different AZs,
wherein the second value is greater than the first value,
wherein the third value is greater than the second value,
wherein the fourth value is greater than the third value, and
wherein the fourth value is based on a number of hops in the external network.

20. The virtual node provisioning method of claim 18, wherein the obtaining of the provisioning request comprises obtaining a provisioning-completed state provisioning request,
wherein the generating of the virtual node provisioning command comprises generating, using the optimization problem solver, another virtual node provisioning command for optimizing provisioning of the service provisioning node of the provisioning-completed state provisioning request, and
wherein the virtual node provisioning method further comprises:
obtaining, from a cloud monitoring server, the first traffic volume between the first virtual node and the second virtual node, the second traffic volume between the first virtual node and the edge node, and the third traffic volume between the first virtual node and the load balancing node are measured traffic volumes.
